(19) United States
(12) Patent Application Publication
(10) Pub. No.: US 2026/0138711 A1
(43) Pub. Date: May 21, 2026

(54) HOODED HANDLE ASSEMBLY OF A WATER VESSEL OR SNOW VESSEL

(71) Applicant: Disney Enterprises, Inc., Burbank, CA (US)

(72) Inventor: Kenneth A. STEVENS, Orlando, FL (US)

(73) Assignee: Disney Enterprises, Inc., Burbank, CA (US)

(21) Appl. No.: 18/955,968

(22) Filed: Nov. 21, 2024

(51) Int. Cl. B63B 32/70; B62B 15/00

(52) U.S. Cl. CPC B63B 32/70; B62B 15/00

(57) ABSTRACT

A handle assembly for a vessel may be configured to navigate a water pathway or a snow pathway. The handle assembly may include a handle connected to an upper surface of the vessel. The handle may have an outboard side facing an outer edge portion of the vessel and an inboard side facing an inner edge portion of the vessel. The handle assembly may include a hooded component sized to at least partially cover the outboard side of the handle such that, when a rider of the vessel places a hand on the handle, the hooded component may protect the hand from contacting (i) a surface defining the water pathway or the snow pathway, or (ii) an object within or adjacent to the water pathway or the snow pathway.

### BACKGROUND

A rider or riders may engage with a water or snow attraction while sitting on or laying down on a water vessel or a snow vessel, respectively. The water vessel or snow vessel may be one of many configurations customized and optimized with a hooded handle assembly or assemblies for its intended safe travel on either water or snow.

### SUMMARY

In some implementations, a handle assembly for a vessel configured to navigate a water pathway or a snow pathway includes a handle connected to an upper surface of the vessel, the handle having an outboard side facing an outer edge portion of the vessel and an inboard side facing an inner edge portion of the vessel; and a hooded component sized to at least partially cover the outboard side of the handle such that when a rider of the vessel places a hand on the handle, the hooded component protects the hand from contacting (i) a surface defining the water pathway or the snow pathway, or (ii) an object within or adjacent to the water pathway or the snow pathway.

In some implementations, a vessel comprising: a handle connected to an upper surface of the vessel, the handle having an outboard side facing an outer edge portion of the vessel and an inboard side facing an inner edge portion of the vessel; and a hooded component sized to at least partially cover the outboard side of the handle such that when a rider of the vessel places a hand on the handle, the hooded component protects the hand from contacting a surface defining a pathway navigated by the vessel or an object within or adjacent to the pathway navigated by the vessel, wherein the vessel comprises a water vessel or a snow vessel.

In some implementations, a vessel comprising: a first handle assembly comprising: a first handle connected to a first side of an upper surface of the vessel, the first handle having a first outboard side facing an outer edge portion of the vessel, and a first hooded component sized to at least partially cover the first outboard side of the first handle; a second handle assembly comprising: a second handle connected to a second side, of the upper surface, opposite the first side, the second handle having a second outboard side facing the outer edge portion, and a second hooded component sized to at least partially cover the second outboard side of the second handle; a third handle assembly comprising: a third handle connected to a third side of the upper surface, the third handle having a third outboard side facing the outer edge portion, and a third hooded component sized to at least partially cover the third outboard side of the third handle; and a fourth handle assembly comprising: a fourth handle connected to a fourth side, of the upper surface, opposite the third side, the fourth handle having a fourth outboard side facing the outer edge portion, and a fourth hooded component sized to at least partially cover the fourth outboard side of the fourth handle.

### BRIEF DESCRIPTION OF THE DRAWINGS

FIG. 1 is a diagram of a top view of an example vessel (i.e., a water vessel or snow vessel) described herein.

FIG. 2 is a diagram of a cross-sectional view of an example vessel (i.e., a water vessel or snow vessel) described herein.

FIG. 3 is a diagram of a side view of an example handle assembly described herein.

FIG. 4 is a diagram of a perspective view of an example handle assembly described herein.

FIG. 5 is a diagram of a top view of an example handle assembly described herein.

FIG. 6 is a diagram of a perspective view of an example vessel (i.e., a water vessel or snow vessel) described herein.

FIG. 7 is a diagram of a cross-sectional view of an example vessel (i.e., a water vessel or snow vessel) described herein.

FIG. 8 is a diagram of an example system of a water or snow attraction having a vessel ride (i.e., a water vessel ride or snow vessel ride) described herein.

FIG. 9 is a diagram of a perspective view of an example vessel (i.e., a water vessel or snow vessel) described herein.

FIG. 10 is a diagram of a perspective view of an example handle assembly described herein.

### DETAILED DESCRIPTION

The following detailed description of example implementations refers to the accompanying drawings. The same reference numbers in different drawings may identify the same or similar elements.

A rider may engage with a water or snow attraction using a vessel (i.e., a water vessel configured for use on/in water or a snow vessel configured for use on snow or ice). The vessel may be a flotation device including, but not limited to, a float, a raft, a board, or a tube. When the vessel is a snow vessel, the vessel may alternatively be a sled (e.g., a toboggan). The water attraction may be, for example, a water slide, a lazy river, a water ride at a water park or amusement park, a wave pool, etc. The snow attraction may be, for example, a tubing course, a

bobsleigh track, a luge track, a downhill ride or course at a resort or park, etc. The rider may sit on or lay down on the vessel while engaged with the water or snow attraction. The vessel may include one or more handles (hereinafter “handles”). The handles may be incorporated, attached, or molded into the vessel. The handles may be used to safely orient and/or position the rider looking forward as their body temporarily becomes “one with the vessel” in riding along a pathway of the water or snow attraction. The handles may generally be of one shape (e.g., “one size fits all”) or may be designed to accommodate different sizes and shapes of hands.

In some situations, the shape of the vessel may help the vessel stay oriented on the pathway without rotation. The rider sitting on the vessel will typically reach out and hold onto the handles which are integrally incorporated, attached, or molded onto the vessel. Once a hand of the rider is placed on the handle, the position of the handle with respect to the vessel determines the stability of the rider and the vessel.

In some situations, the pathway may include surfaces such as a wall bounding the pathway or an object provided within or adjacent to the pathway. In some instances, the pathway may be partially or fully enclosed at locations along the pathway (e.g., an enclosed tubular portion of a slide or tunnel). The handles may be located on a top surface of the vessel and inboard. The term “inboard” may refer to a location that is toward an inner edge portion of the vessel (i.e., closer to the rider). By being located inboard, the handles may protect the hands of the rider from unintentionally contacting a surface of the pathway. When the vessel moves forward and gains speed, a rider may hold on tight to the handles and pull up, which may further increase a speed of the vessel and may increase the tendency for the vessel to ride high up on the tubular pathway wall in the turns of the pathway with less individual control of the vessel. This feeling of losing control tends to make a rider want to reach outboard to slow the vessel down.

To do this, a rider would have to let go of the handles, and grab hold of the vessel itself. Locating the handles more “outboard” on the vessel accommodates the rider's desire to reach outboard and grab the handles.

In some instances, the handles may be located on the top surface of the vessel and outboard. The term “outboard” may refer to a location that is toward an outer edge portion of the vessel (i.e., further away from the rider). The handles may be located outboard to increase a level of stability of the vessel. Additionally, the handles may be located outboard to enhance a level of thrill experienced by the rider. For example, the location of the handles may cause the rider to extend the arms of the rider, thereby increasing the moment of inertia of the vessel. In some situations, the location of the handles may increase the possibility of the rider's hand unintentionally contacting a surface of the pathway.

In some instances, the vessel may be floating or sliding down an open flume (that is part of the pathway) and may be free to rotate completely. In some situations, the rotation of the vessel may increase the possibility of the rider's hand unintentionally contacting the pathway or an object adjacent to the pathway as the vessel rotates.

Accordingly, a need exists to provide the handles on a vessel to increase a level of stability and/or a level of control of the vessel, while preventing unintentional contact of the rider's hand(s) with a surface of the pathway or a surface of an object within or adjacent to the pathway.

Implementations described herein are directed to a hooded handle assembly that protects a rider's hand against unintentional contact with a surface of the pathway or a surface of an object within or adjacent to the pathway while increasing stability and control of the water vessel. In some implementations, the hooded handle assembly may be provided outboard at an

outer edge portion of the vessel. In other implementations, the hooded handle assembly may be provided inboard at an inner edge portion of the vessel or anywhere in between. In further implementations, the hooded handle assembly may be provided at a mid-portion between the outer edge portion and the inner edge portion. In this regard, implementations described herein will shield the hand of the rider from any direct contact with surfaces of the pathway or objects within or adjacent to the pathway as the vessel travels.

In some situations, the rider may hold on tight to the handle and pull up on the handle. Pulling up on the handle in this manner may further increase a speed of the vessel and may increase a tendency for the vessel to ride elevated in turns of the pathway with less control of the vessel. In this regard, the hooded handle assembly may increase the confidence of the rider and the ability of the rider to control the vessel by enabling the rider to safely and intentionally use the handle to lift up the vessel or press the vessel down to control a speed and/or a direction of the vessel.

In some implementations, the handle may be provided on a top surface of the vessel and a hooded component of a hooded handle assembly may extend at an angle from the top surface to fully or partially cover an outboard side of the handle. In other examples, the handle may be provided on the top surface of the vessel and the hooded component of the hooded handle assembly may extend at an angle from the top surface to fully or partially cover an inboard side of the handle. In examples where the hooded component covers the outboard side of the handle or the inboard side of the handle, the hooded component may further extend to fully or partially cover a top surface of the handle. In some examples, the handle may be provided on a side surface of the vessel.

In some examples, the hooded component may be integrated into the vessel. The hooded component may comprise a thermoplastic material, a plastic material, a vinyl material, a rubber material, a foam material, or an elastomer material.

Implementations described herein may be used in connection with snow attractions (e.g., snow slide systems), water attractions (e.g., water slide systems, lazy rivers, wave pools), water rides at a water park or amusement park, watersports, snow sports, and watercrafts, such as boats. The term “vessel” may be used to refer to a water vessel or a snow vessel. The term “water vessel” may be used to refer to a flotation device including a raft, a water slide tube, an inner tube, a tubular float, and/or a board, among other examples of devices with handles that may be used to float on or to navigate a body of water. The term “snow vessel” may be used to refer to a flotation device including a raft, a tube, and/or a board; or a sled including a toboggan, a runner sled, a disk, or a backcountry sled, among other examples of devices with handles that may be used to slide on or navigate snow or ice. The vessel may be of various shapes or sizes. The vessel may accommodate a single ride or multiple riders. The vessel may be used in connection with an open flume of water, a fully or partially enclosed pathway (e.g., a tubular pathway), a watercraft (e.g., on a lake, a bay, a lagoon, a river, an ocean, or any other open body of water) or a snowcraft (e.g., on a snow covered hill or mountain, a body of frozen water (i.e., ice), or any other frozen surface). For example, the vessel may be used as a towable vessel behind a boat or snowmobile. The vessel may be used in a ride whose course may be horizontally configured over any expanse and may include a vertical drop of any height. The snow vessel may be of various shapes and sizes. The snow vessel may accommodate a single rider or multiple riders. The snow vessel may be used in a wide open field, or on a guided snow attraction configuration of any shape or size.

In some implementations, the hooded component may be sized to at least partially cover the outboard side of the handle such that when a rider of the vessel places a hand on the handle, the hooded component protects the hand from contacting a surface defining the pathway or an object within or adjacent to the pathway. In some implementations, the hooded component may be sized to further cover at least a portion of a top surface of the handle. In some implementations, the hooded component may be sized to fully cover the outboard side of the handle.

While implementations herein may be described with respect to a hooded component of a handle assembly of a vessel, implementations herein are applicable to a hooded component of a handle assembly for a handle of different objects. The different objects may include a handle of a bicycle, a handle of a motorcycle, a handle of an umbrella, a handle of a ski pole, a handle of a fireplace poker, or a handle of a luggage, among other objects.

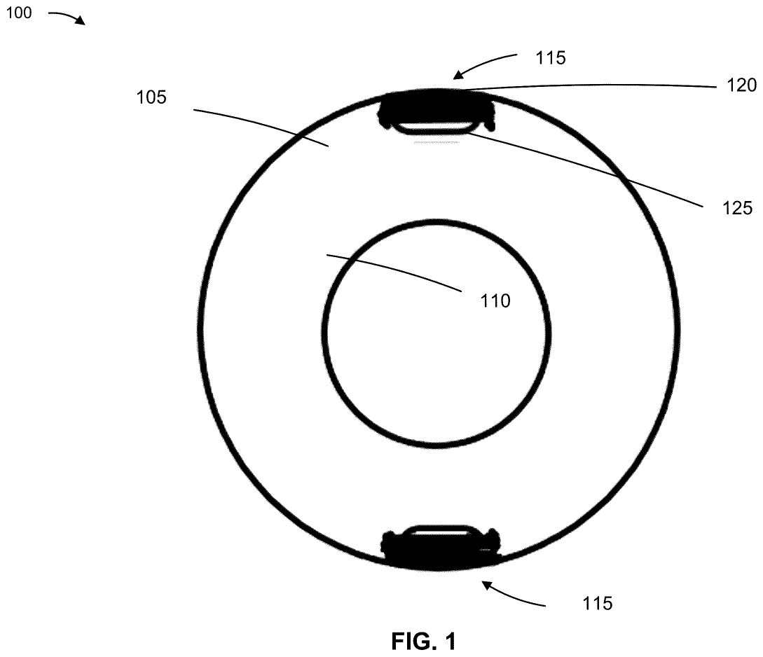

FIG. 1 is a diagram of a top view of an example vessel 100 described herein. As shown in FIG. 1, in some examples, vessel 100 may be an inner tube. In some examples, vessel 100 may be an inflatable vessel. As shown in FIG. 1, vessel 100 may include an outer edge portion 105 and an inner edge portion 110. As shown in FIG. 1, vessel 100 may include a handle assembly 115. Handle assembly 115 may include a hooded component 120 and a handle 125. As shown in FIG. 1, handle assembly 115 may be provided on outer edge portion 105. By providing handle assembly 115 on outer edge portion 105, a rider of vessel 100 may experience more stability when riding vessel 100. Additionally, by providing handle assembly 115 on outer edge portion 105, the rider may control a speed of vessel 100 moving (or floating) on a body of water or sliding on snow or a frozen surface (e.g., ice).

As shown in FIG. 1, hooded component 120 may cover a portion of handle 125. For example, hooded component 120 may cover an outboard side of handle 125. The outboard side may refer to a side of handle 125 that faces outer edge portion 105 (i.e., faces away from the rider). Hooded component 120 may wrap around a portion of ends of handle 125. In some situations, hooded component 120 may cover a portion of a top surface of handle 125.

By covering the portion of handle 125 and wrapping around the portion of the ends of handle 125, hooded component 120 may protect the hand of a rider of vessel 100 (e.g., from unintentional contact with surfaces defining the pathway or objects within or adjacent to the pathway navigated by vessel 100). By protecting the hand of the rider, hooded component 120 may increase a measure of confidence of the rider and, accordingly, improve the ability of the rider to control vessel 100 by enabling the rider to intentionally use handle 125 to control a speed and/or a movement of vessel 100. For example, the rider may confidently use handle 125 to lift up vessel 100 or to press vessel 100 down to control a speed and/or a direction of vessel 100.

As shown in FIG. 1, vessel 100 may include more than a single handle assembly 115 (e.g., two or more). In some situations, a quantity of handle assembly 115 may increase based on a size or an occupancy of vessel 100. A size of vessel 100 may be increased to support more than a single rider. In examples in which the vessel is intended to be occupied by two riders, the vessel 100 may include four handle assemblies 115 (i.e., one handle assembly per each hand of each rider). In some examples, vessel 100 may include a single handle assembly.

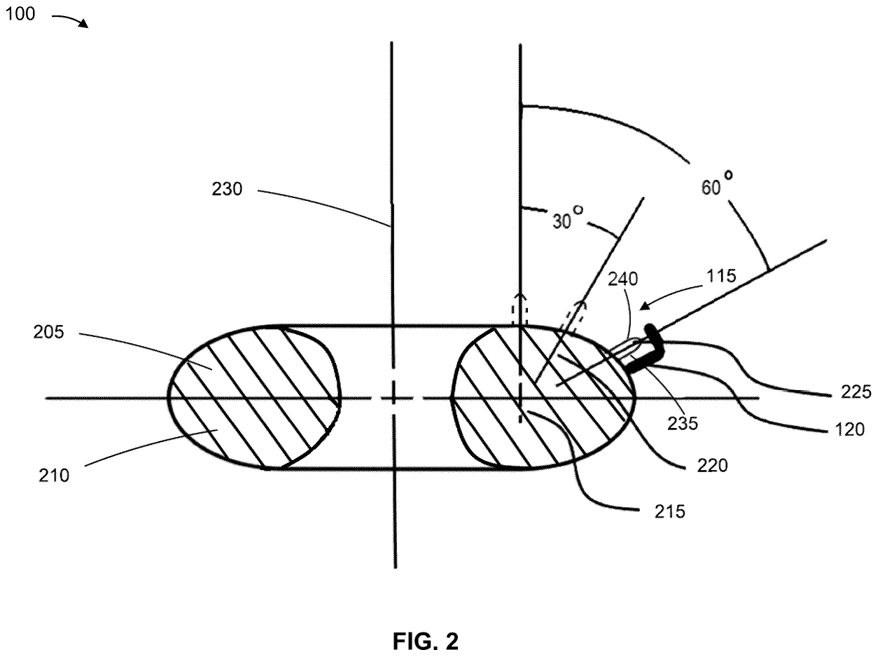

FIG. 2 is a diagram of a side view of an example vessel 100 described herein. Elements of vessel 100 have been described above in connection with FIG. 1. As shown in FIG. 2, vessel 100 may include an upper surface 205 and a lower surface 210 that is opposite upper surface 205. Lower surface 210 may correspond to a surface of vessel 100 that is submerged under water. In some examples, upper surface 205 and lower surface 210 may be connected by a welded seamline.

As shown in FIG. 2, handle assembly 115 may be provided at various locations on upper surface 205. For example, handle assembly 115 may be provided at a first position 215. In this regard, handle assembly 115 may be provided on or near inner edge portion 110 of vessel 100. As shown in FIG. 2, handle assembly 115 may be provided at a second position 220 configured radially further from a center 230 of vessel 100 than first position 215. In some examples, first position 215 and second position 220 may be separated by 30 or more degrees.

As shown in FIG. 2, handle assembly 115 may be provided at a third position 225 configured radially further from the center 230 of vessel 100 than second position 220. In some examples, first position 215 and third position 225 may be separated by 60 or more degrees. Handle assembly 115 may be provided at third position 225 to improve stability of vessel 100 and/or to enable the rider to improve control of vessel 100. As shown in FIG. 2, handle assembly 115 may be configured radially further from a center 230 of vessel 100 than third position 225.

As shown in FIG. 2, handle 125 may include an outboard side 235 and an inboard side 240 that is opposite outboard side 235. The term “outboard side” may refer to a side of handle 125 facing outer edge portion 105 of vessel 100. The term “inboard side” may refer to a side of handle 125 facing inner edge portion 110 of vessel 100. As shown in FIG. 2, hooded component 120 may partially or fully cover outboard side 235. In other words, hooded component 120 may be provided between outboard side 235 of handle 125 and outer edge portion 105 of vessel 100. As shown in FIG. 2, in some examples, hooded component 120 may cover a top surface of handle 125. Hooded component 120 may be configured to protect a hand of a rider of vessel 100 when the hand engages handle 125.

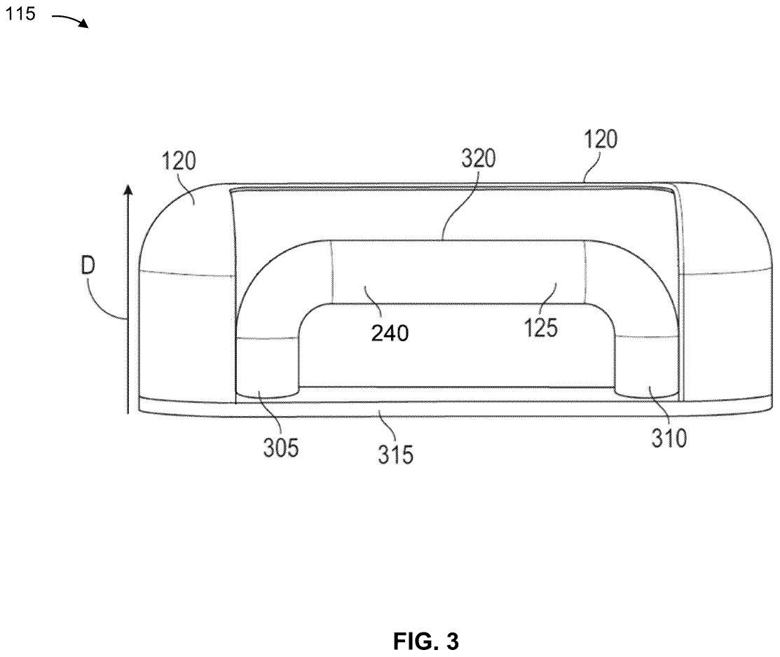

FIG. 3 is a diagram of a side view of handle assembly 115 described herein. Elements of handle assembly 115 have been described above in connection with FIG. 1 and FIG. 2. As shown in FIG. 3, handle 125 may include a first end 305, a second end 310, and a top surface 320. First end 305 and second end 310 of handle 125 may be connected to directly to upper surface 205 of vessel 100 or to a base 315 connected to upper surface 205 of vessel 100. First end 305 and second end 310 may extend perpendicular from base 315 or from upper surface 205 of vessel 100 to connect to upper surface 205. In this regard, first end 305, second end 310, and upper surface 205 may form a U. In other others, handle 125 may be U-shape. In some examples, first end 305 and second end 310 of handle 125 may be molded into base 315. In addition to or alternatively, base 315 may be molded into upper surface 205 of vessel 100.

As shown in FIG. 3, hooded component 120 may extend in a direction D from base 315 or from upper surface 205 of vessel 100. In some examples, direction D may be perpendicular to base 315 and/or to upper surface 205. As shown in FIG. 3, hooded component 120 may cover an entirety of outboard side 235 (not shown) opposite inboard side 140.

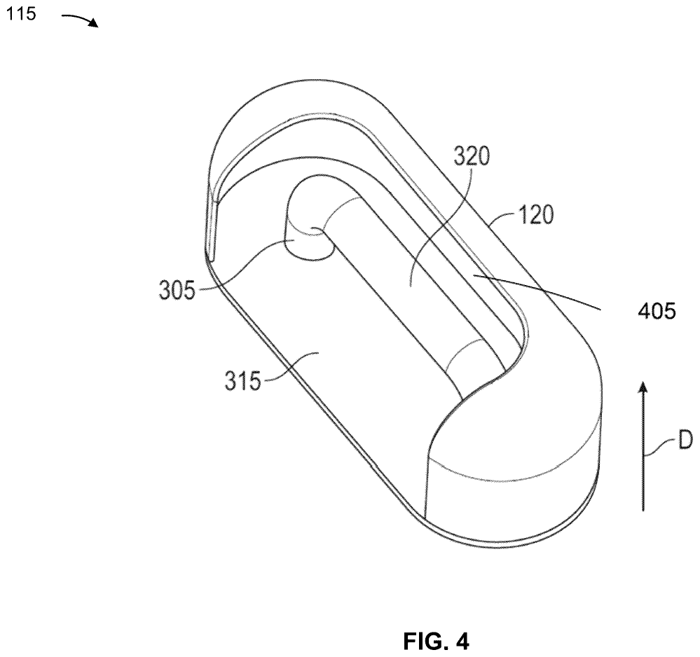

FIG. 4 is a diagram of a perspective view of handle assembly 115 described herein. Elements of handle assembly 115 have been described above in connection with FIGS. 1-3. As shown in FIG. 4, in some examples, base 315 of handle 125 may have a rectangular shape with rounded edges. This view clearly shows the opening in the hooded component that accommodates a rider's hand on top of handle 125 being protected on 3 sides by hooded component 120. For example, the hand of the rider may be received in opening 405 between handle 125 and hooded component 120. The hand may wrap around handle 125 (e.g., wrap around top surface 320).

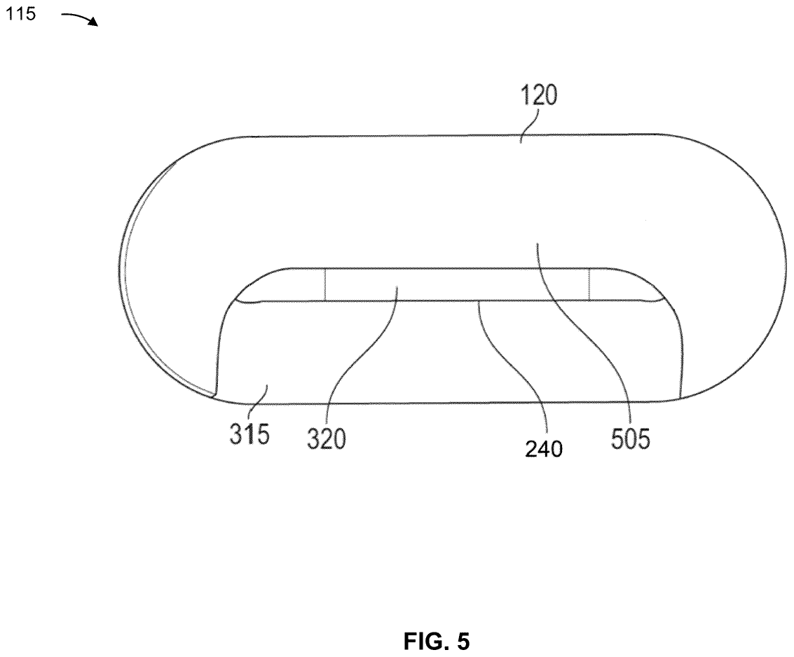

FIG. 5 is a diagram of a top view of handle assembly 115 described herein. Elements of handle assembly 115 have been described above in connection with FIGS. 1-4. As shown in FIG. 5, in some examples, hooded component 120 may have a rectangular shape with rounded edges. As shown in FIG. 5, hooded component 120 may be extended parallel to cover a portion or all of handle top surface 320 of handle 125. For example, hooded component 120 may include an extended portion 505 that covers a portion or all of top surface 320.

Hooded component 120 may wrap around first end 305 (not shown) of handle 125 to cover a first portion of inboard side 240. Additionally, or alternatively, hooded component 120 may wrap around second end 310 (not shown) of handle 125 to cover a second portion of inboard side 240 (e.g., opposite the first portion of inboard side 240). In some examples, a configuration of hooded component 120 (as shown in FIG. 5) may become more appropriate for when handle assembly 115 is provided closer to outer edge portion 105 (e.g., provided at third position 225). In other words, hooded component 120 may become more appropriate for protecting the hand of the rider the further outboard handle assembly 115 is positioned, as the vulnerability of coming in contact with the pathway increases the closer the hand is to the pathway.

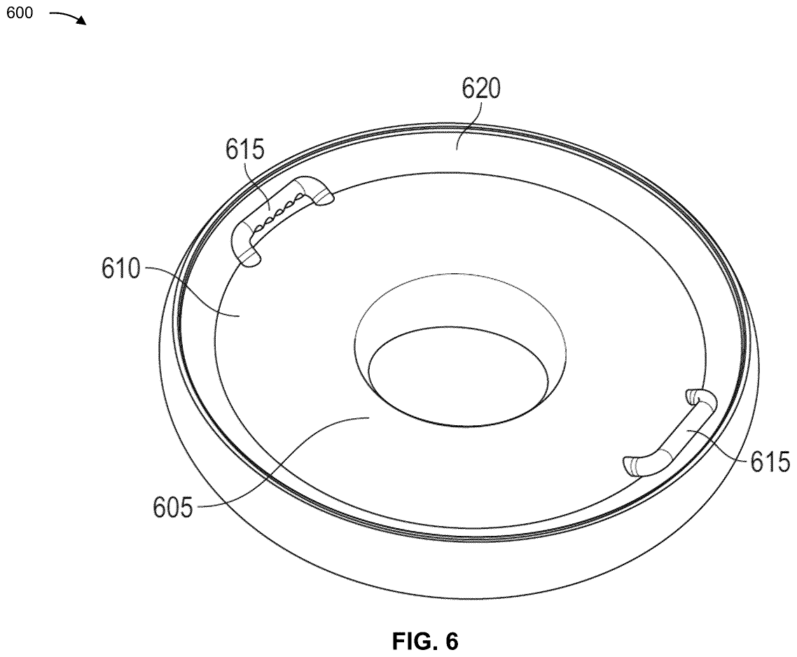

FIG. 6 is a diagram of a perspective view of a vessel 600 described herein. Vessel 600 may be similar to vessel 100. For example, vessel 600 may include an inner tube that includes inner edge portion 605 and outer edge portion 610 on an upper surface of vessel 600. Vessel 600 may include one or more handles 615 provided on outer edge portion 610. As shown in FIG. 6, vessel 600 may include a hooded component 620. Unlike hooded component 120, as shown in FIG. 6, hooded component 620 may be molded and integrated into outer edge portion 610.

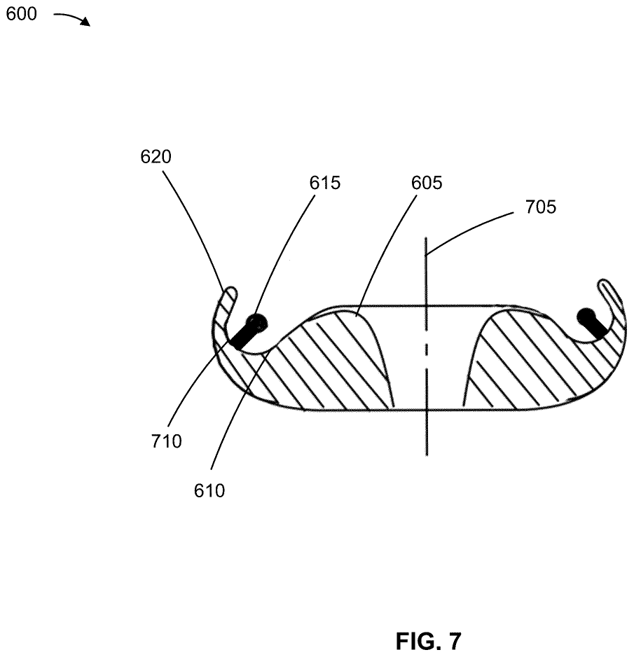

Further details regarding the structure and operation of hooded component 620 will be described with respect to the description of FIG. 7.

FIG. 7 is a diagram of a cross-sectional view of a vessel 600 described herein. Elements of vessel 600 have been described above in connection with FIG. 6. As shown in FIG. 7, handle 615 may be configured at different positions radially away from a center 705 of vessel 600. As shown in FIG. 7, hooded component 620 may cover a portion of handle 615. For example, hooded component 620 may form a barrier or shield between handle 615 and objects external to vessel 600. As shown in FIG. 7, handle 615 may be provided in a recessed portion 710. Hooded component 620 may be raised and/or extend above handle 615 to a hand of a rider. Additionally, or alternatively, hooded component 620 may be raised and/or extend above outer edge portion 610,

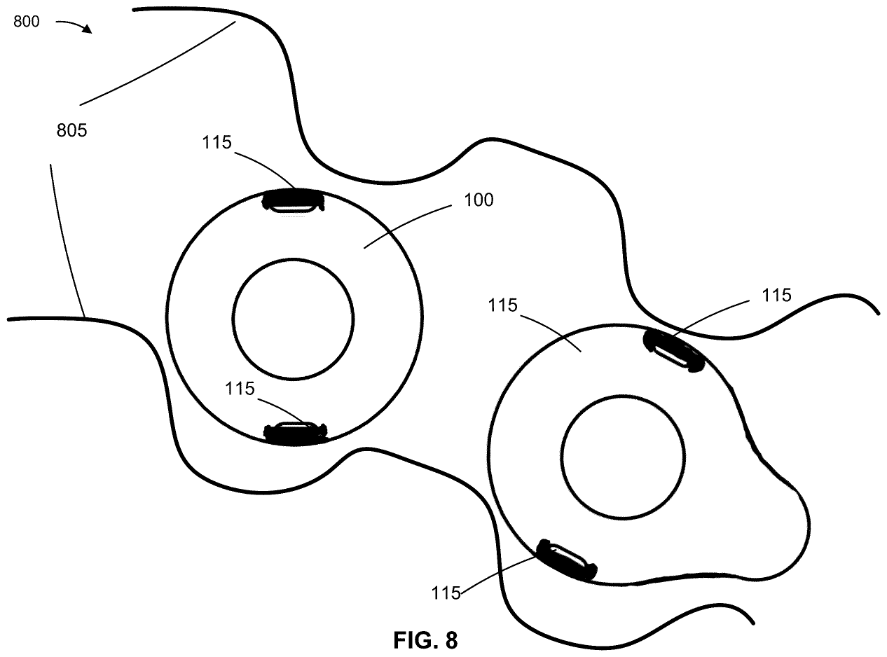

FIG. 8 is a diagram of an example system of a vessel attraction 800 (e.g., a water attraction or a snow attraction). As shown in FIG. 8, vessel attraction 800 may include a pathway 805. Pathway 805 may be part of an open flume of water, a snow course or track, or a course or track having a frozen surface (e.g., ice). Alternatively, pathway 805 may include a fully or partially enclosed tubular pathway. As shown in FIG. 8, vessel attraction 800 may include multiple vessels 100. Vessels 100 may be floating or sliding down pathway 805. The handle assembly 115 protects a rider's hand from contacting walls defining the pathway 805.

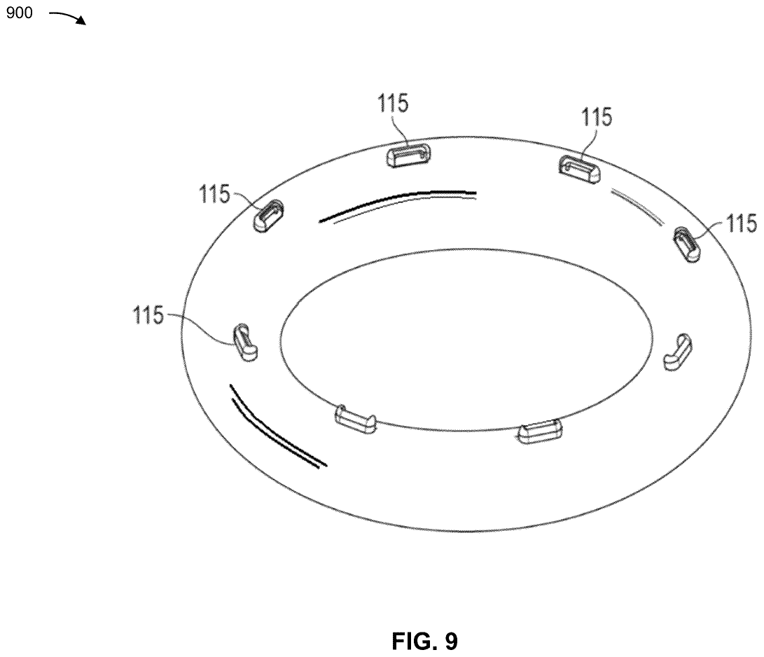

FIG. 9 is a diagram of an example vessel 900. As shown in FIG. 9, vessel 900 may include a raft or tube that accommodates multiple riders (e.g., more riders than vessel 100 may accommodate). As shown in FIG. 9, vessel 900 may include more than one handle assembly 115.

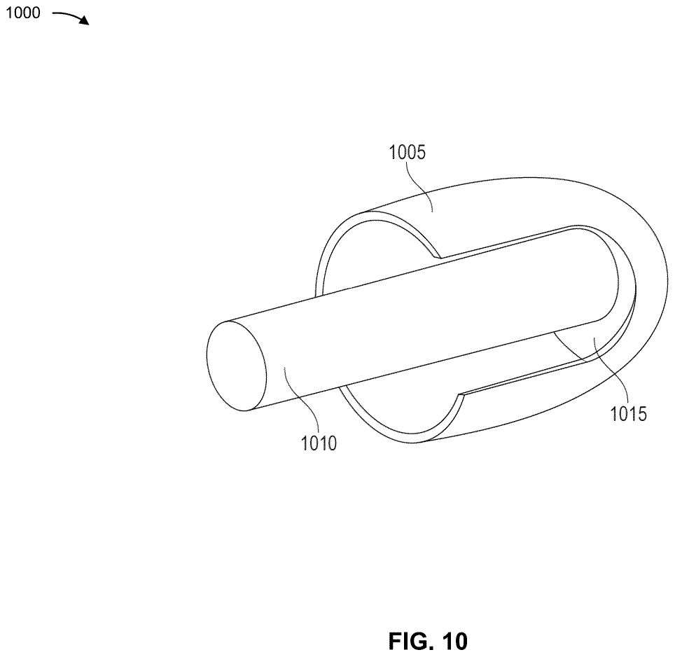

FIG. 10 is a diagram of a perspective view of an example handle assembly 1000. As shown in FIG. 10, handle assembly 1000 may include a hooded component 1005, a handle 1010, and a base 1015. As shown in FIG. 10, a proximal end of handle 1010 may be connected to or integrated with the base 1015, while a distal end of handle 1010 does not contact the base 1015. The handle 1010 may extend from base 1015 at an angle. In some examples, handle 1010 may be perpendicular to base 1015. As shown in FIG. 10, a proximal end of hooded component 1005 may be connected to or integrated with the base 1015, while a distal end of hooded component 1005 does not contact the base 1015. Similar to handle 1010, hooded component 1005 may extend from base 1015 at an angle, for example, a same angle as the angle from which handle 1010 extends from the base. In some examples, hooded component 1005 is perpendicular to base 1015. Hooded component 1005 may fully or partially cover a portion of handle 1010. In some examples, hooded component 1005 may cover at least 50 percent of handle 1010.

As shown in FIG. 10, in some examples, base 1015 may have a circular shape. As shown in FIG. 10, in some examples, handle 1010 may have a cylindrical shape. Handle 1010 may include a handle of a snow mobile, a handle of a jet ski, a handle of a bicycle, a handle of a motorcycle, a handle of an umbrella, a handle of a ski pole, or a handle of a luggage, among other objects.

The foregoing disclosure provides illustration and description but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the handle assembly in use or operation in addition to the orientation depicted in the figures. The handle assembly may be otherwise oriented (rotated 90 degrees or at other orientations) and the spatially relative descriptors used herein may likewise be interpreted accordingly.

What is claimed is:

1. A handle assembly for a vessel configured to navigate a water pathway or a snow pathway, the handle assembly comprising:
a handle connected to an upper surface of the vessel, the handle having an outboard side facing an outer edge portion of the vessel and an inboard side facing an inner edge portion of the vessel; and
a hooded component sized to at least partially cover the outboard side of the handle such that when a rider of the vessel places a hand on the handle, the hooded component protects the hand from contacting (i) a surface defining the water pathway or the snow pathway, or (ii) an object within or adjacent to the water pathway or the snow pathway.

2. The handle assembly of claim 1, wherein the handle assembly is provided on the outer edge portion of the upper surface of the vessel.

3. The handle assembly of claim 1, wherein the hooded component is sized to fully cover the outboard side of the handle.

4. The handle assembly of claim 1, wherein the hooded component is sized to further cover at least a portion of a top surface of the handle.

5. The handle assembly of claim 1, wherein the hooded component comprises a thermoplastic material, a plastic material, a vinyl material, a rubber material, a foam material, or an elastomer material.

6. The handle assembly of claim 1, wherein the vessel comprises a flotation device or a sled.

7. The handle assembly of claim 1, wherein the vessel is configured for use in a water attraction or a snow attraction.

8. A vessel comprising:
a handle connected to an upper surface of the vessel, the handle having an outboard side facing an outer edge portion of the vessel and an inboard side facing an inner edge portion of the vessel; and
a hooded component sized to at least partially cover the outboard side of the handle such that when a rider of the vessel places a hand on the handle, the hooded component protects the hand from contacting a surface defining a pathway navigated by the vessel or an object within or adjacent to the pathway navigated by the vessel,
wherein the vessel comprises a water vessel or a snow vessel.

9. The vessel of claim 8, wherein the vessel includes a floatation device or a sled.

10. The vessel of claim 8, wherein the hooded component is integrated with the outer edge portion of the upper surface of the vessel and the handle is provided in a recessed portion of the upper surface of the vessel.

11. The vessel of claim 8, wherein the hooded component comprises a thermoplastic material, a plastic material, a vinyl material, a rubber material, or an elastomer material.

12. The vessel of claim 8, wherein the handle and the hooded component are provided on the outer edge portion of the upper surface of the vessel.

13. The vessel of claim 8, wherein the hooded component is integrated into the vessel.

14. The vessel of claim 8, wherein the hooded component is sized to fully cover the outboard side of the handle.

15. The vessel of claim 8, wherein the hooded component is sized to further cover at least a portion of a top surface of the handle.

16. The vessel of claim 8, wherein the handle is a first handle provided on a first side of the upper surface,
wherein the hooded component is a first hooded component provided on the first side of the upper surface, and
wherein the vessel further comprises:
a second handle provided on a second side, of the upper surface, opposite the first side, and
a second hooded component provided on the second side of the upper surface.

17. A vessel comprising:
a first handle assembly comprising:
a first handle connected to a first side of an upper surface of the vessel, the first handle having a first outboard side facing an outer edge portion of the vessel, and
a first hooded component sized to at least partially cover the first outboard side of the first handle;
a second handle assembly comprising:
a second handle connected to a second side, of the upper surface, opposite the first side, the second handle having a second outboard side facing the outer edge portion, and
a second hooded component sized to at least partially cover the second outboard side of the second handle;
a third handle assembly comprising:
a third handle connected to a third side of the upper surface, the third handle having a third outboard side facing the outer edge portion, and
a third hooded component sized to at least partially cover the third outboard side of the third handle; and
a fourth handle assembly comprising:
a fourth handle connected to a fourth side, of the upper surface, opposite the third side, the fourth handle having a fourth outboard side facing the outer edge portion, and
a fourth hooded component sized to at least partially cover the fourth outboard side of the fourth handle.

18. The vessel of claim 17, wherein the vessel comprises a water vessel or a snow vessel.

19. The vessel of claim 17, wherein the vessel comprises a floatation device or a sled.

20. The vessel of claim 17, wherein at least one of the first handle assembly, the second handle assembly, the third handle assembly, or the fourth handle assembly is provided on the outer edge portion of the upper surface of the vessel.
